(19) United States
(12) Patent Application Publication
(10) Pub. No.: US 2025/0053397 A1
(43) Pub. Date: Feb. 13, 2025

(54) SYSTEM AND METHOD FOR TRANSLATING A FIRST CODING LANGUAGE INTO A SECOND CODING LANGUAGE

(71) Applicant: THE BANK OF NEW YORK MELLON, New York, NY (US)

(72) Inventor: Jisoo LEE, New York, NY (US)

(21) Appl. No.: 18/790,613

(22) Filed: Jul. 31, 2024

Related U.S. Application Data
(60) Provisional application No. 63/531,189, filed on Aug. 7, 2023.

(51) Int. Cl. G06F 8/51

(52) U.S. Cl. CPC G06F 8/51

(57) ABSTRACT

Systems and methods for translating a first coding language into a second coding language train a machine learning (ML) model on a first coding language specific data set relating to the first coding language, in which the ML model is trained to translate one or more code sets of the first coding language to respective one or more code sets of the second coding language; using the ML model, generate various unit test cases, in which the unit test cases run the one or more code sets of the second coding language in parallel with the one or more code sets of the first coding language; iteratively test and refine the ML model until a maturity threshold is reached; and upon reaching the maturity threshold, containerize the one or more code sets of the second coding language into one or more applications.

### CROSS-REFERENCE TO RELATED APPLICATIONS

This application claims priority to U.S. Provisional Application No. 63/531,189, filed Aug. 7, 2023, the subject matter of which is incorporated herein by reference in its entirety.

### BACKGROUND

Mainframe systems have been used in the financial industry for several decades and Common Business Oriented Language (commonly referred to as COBOL) has been the prominent programming language since 1960s. Thanks to many decades of development and technology advancements, both the Mainframe and COBOL have become integral part of business functions as well as providing efficient intraday and overnight processing operations. However, with the emergence of distributed systems, modern programming languages, as well as public cloud services, subject matter experts in both Mainframe technology and COBOL are increasingly difficult to acquire and the critical institutional knowledge for existing implementations and business logics are also declining rapidly for many large organizations.

Current Mainframe modernization techniques typically involve manually analyzing COBOL codes and individually rewriting them into modernized code languages. This can be error-prone and resource intensive in terms of subject-matter-experts and time it takes to achieve acceptable conversion/outcome.

Although Machine Learning (ML) and Artificial Intelligence (AI) have been under development for many decades, prior art systems have struggled to yield meaningful results and adequate accuracy in interpreting programming languages, converting to different programming languages, and achieving processing parity.

Accordingly, systems and methods are needed which enable the ability to programmatically modernize COBOL (and other computer languages) applications and their business logics into modern programming languages as well as optimize processing efficiency so that large organizations can reduce risks associated with operating critical business functions on legacy systems.

### SUMMARY

Aspects of the disclosure relate to methods, apparatuses, and/or systems for translating a first coding language into a second coding language.

In some aspects, the techniques described herein relate to a method for translating a first coding language into a second coding language, including: training, by a processor, a first machine learning (ML) model at least in part on a first coding language specific data set relating to the first coding language, in which the first ML model is trained to translate one or more code sets of the first coding language to respective one or more code sets of the second coding language; using the first ML model, generating, by the processor, at least one unit test case, in which the at least one unit test case runs the one or more code sets of the second coding language in parallel with the one or more code sets of the first coding language; iteratively testing and refining, by the processor, the first ML model based at least in part on a maturity level of the first ML model until a maturity threshold is reached; and upon reaching the maturity threshold, containerizing by the processor, the one or more code sets of the second coding language into an application.

In some aspects, the techniques described herein relate to a method, in which the first coding language specific data set includes one or more of at least one of a language reference document, library, historical input file, historical output file, runtime log, parameter set, or control point, relating to a first coding language.

In some aspects, the techniques described herein relate to a method, in which the first coding language is Common Business-Oriented Language (COBOL).

In some aspects, the techniques described herein relate to a method, in which the second coding language is one of Java, Golang, Python, Angular, or C++.

In some aspects, the techniques described herein relate to a method, in which the first machine learning model is a Natural Language Model (NLM).

In some aspects, the techniques described herein relate to a method, in which iteratively testing the first ML model includes: implementing a plurality of iterative regression tests based on historical input data of at least one of the one or more code sets of the first coding language and comparing corresponding output data of the first ML model against historical output of the at least one of the one or more code sets of the first coding language.

In some aspects, the techniques described herein relate to a method, in which iteratively refining the first ML model includes: executing, by the processor, one or more debugging techniques; and updating the first ML model based on the one or more executed debugging techniques.

In some aspects, the techniques described herein relate to a method, further including: dynamically scaling, by the processor, one or more containerized applications based at least in part on one or more of a second ML model or at least one second unit test case that has reached the maturity threshold.

In some aspects, the techniques described herein relate to a method, further including: tracking, by the processor, progress of the at least one test case based at least in part on the maturity level of the first ML model.

In some aspects, the techniques described herein relate to a system for translating a first coding language into a second coding language, including: a computer having a processor and a memory; and one or more code sets stored in the memory and executed by the processor, which, when executed, configure the processor to: train a first machine learning (ML) model at least in part on a first coding language specific data set relating to the first coding language, in which the first ML model is trained to translate one or more code sets of the first coding language to respective one or more code sets of the second coding language; using the first ML model, generate at least one unit test case, in which the at least one unit test case runs the one or more code sets of the second coding language in parallel with the one or more code sets of the first coding language; iteratively test and refine the first ML model based at least in part on a maturity level of the first ML model until a maturity threshold is reached; and upon reaching the maturity threshold, containerize the one or more code sets of the second coding language into an application.

In some aspects, the techniques described herein relate to a system, in which the first coding language specific data set includes one or more of at least one of a language reference document, library, historical input file, historical output file, runtime log, parameter set, or control point, relating to a first coding language.

In some aspects, the techniques described herein relate to a system, in which the first coding language is Common Business-Oriented Language (COBOL).

In some aspects, the techniques described herein relate to a system, in which the second coding language is one of Java, Golang, Python, Angular, or C++.

In some aspects, the techniques described herein relate to a system, in which the first machine learning model is a Natural Language Model (NLM).

In some aspects, the techniques described herein relate to a system, in which, when iteratively testing the first ML model, the processor is further configured to: implement a plurality of iterative regression tests based on historical input data of at least one of the one or more code sets of the first coding language and comparing corresponding output data of the first ML model against historical output of the at least one of the one or more code sets of the first coding language.

In some aspects, the techniques described herein relate to a system, in which when iteratively refining the first ML model, the processor is further configured to: execute one or more debugging techniques; and update the first ML model based on the one or more executed debugging techniques.

In some aspects, the techniques described herein relate to a system, in which the processor is further configured to: dynamically scale one or more containerized applications based at least in part on one or more of a second ML model or at least one second unit test case that has reached the maturity threshold.

In some aspects, the techniques described herein relate to a system, in which the processor is further configured to: track progress of the at least one test case based at least in part on the maturity level of the first ML model.

In some aspects, the techniques described herein relate to a non-transitory computer-readable medium storing computer-program instructions that, when executed by one or more processors, cause the one or more processors to effectuate operations including: training a first machine learning (ML) model at least in part on a first coding language specific data set relating to the first coding language, in which the first ML model is trained to translate one or more code sets of the first coding language to respective one or more code sets of the second coding language; using the first ML model, generating at least one unit test case, in which the at least one unit test case runs the one or more code sets of the second coding language in parallel with the one or more code sets of the first coding language; iteratively testing and refining the first ML model based at least in part on a maturity level of the first ML model until a maturity threshold is reached; and upon reaching the maturity threshold, containerizing the one or more code sets of the second coding language into an application.

In some aspects, the techniques described herein relate to a non-transitory computer-readable medium, in which the first coding language is Common Business-Oriented Language (COBOL); and in which the second coding language is one of Java, Golang, Python, Angular, or C++.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for translating a first coding language into a second coding language, in accordance with at least one embodiment;

FIG. 2 illustrates an example code translation application in accordance with at least one embodiment;

FIG. 3 depicts an example method for translating a first coding language into a second coding language, in accordance with at least one embodiment;

FIG. 4 shows an example of a layman summary produced based on a code set, according to some embodiments; and

FIG. 5 shows an example of a legacy code set and a translated modernized code set, according to some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments of the invention.

The systems and methods described herein may be implemented in numerous practical applications. For example, the advantages described herein for using machine learning models that translate mainframe code to modernized code and/or micro services may be applicable to other environments, system configurations, and sets of programming languages. For example, while the systems and methods described herein generally refer to translating COBOL to other computer programming languages such as Java, it will be understood by those skilled in the art that the same or similar techniques may be implemented to enable translation between any two computer programming languages.

To mitigate the problems described herein, the inventor had to both invent solutions and, in some cases just as importantly, recognize problems overlooked (or not yet foreseen) by others in the field of identifying, evaluating, and repairing a break. Indeed, the inventor wishes to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Embodiments use ML/AI tools to train code (e.g., COBOL) translation models based on historical processed dataset and parallel run-time processing lanes to compare input/output data. Embodiments of the systems and methods described herein provide technical solutions that accurately translate code from one computer language into another computer language (e.g. COBOL to java) and iteratively ensure consistent data quality and processing. Further embodiments provide a containerized microservice architecture achieving processing efficiency and scale in performance and resource consumptions.

As used herein, a mainframe computer, informally called a mainframe or big iron, is a computer used primarily by large organizations for critical applications like bulk data processing for tasks such as censuses, industry and consumer statistics, enterprise resource planning, and large-scale transaction processing. The term mainframe was derived from the large cabinet, called a main frame, that housed the central processing unit and main memory of early computers.

Common Business-Oriented Language, or COBOL, is programming language used in mainframe computing. It is a compiled English-like programming language designed for business use. It is an imperative, procedural and, since 2002, object-oriented language. COBOL is widely used in applications deployed on mainframe computers, such as large-scale batch and transaction processing jobs.

As used herein, Machine Learning is a subdomain of Artificial Intelligence that is concerned with systems that are able to acquire their own “knowledge” by extracting patterns from raw data, rather than that knowledge being hard-coded.

As used herein, Artificial intelligence (AI) is intelligence—perceiving, synthesizing, and/or inferring information—demonstrated by machines, as opposed to intelligence displayed by non-human animals or by humans. Example tasks in which this is done include speech recognition, computer vision, translation between (natural) languages, as well as other mappings of inputs.

As used herein, microservice architecture (“microservices”) is a variant of the service-oriented architecture structural style. It is an architectural pattern that arranges an application as a collection of loosely coupled, fine-grained services, communicating through lightweight protocols.

As used herein, Test Driven Development (TTD) is a software development process relying on software requirements being converted to test cases before software is fully developed, and tracking all software development by repeatedly testing the software against all test cases.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

As explained in further detail herein, in order to generate accurate COBOL to modern language translation Natural Language Models (NLMs), a foundational COBOL language knowledge set may be constructed. This information may be based on various COBOL language reference documents, examples, codes, and/or other sources. Similarly, foundational knowledge sets for target modern languages may be built. Once the foundational language knowledge sets have been established, NLMs may process the original mainframe COBOL codes, their libraries and/or any other documents and structures. This phase of the ML training allows each of the NLMs to be exposed to specific COBOL applications and related data sets to build its own understanding of its functions and logics. In some embodiments, as described herein, to test NLM maturity, an NLM may be queried to produce a layman summary of specific portions of the applications, functions, and/or its logics. This phase may be beneficial in documenting institutional knowledge and creating a basis for version-controlled code enhancements.

It should be noted that in addition to and/or as an alternative to NLMs, in various embodiments, other types of models that are able to process large data sets may be used. For example, Large Language Models (LLMs) are machine learning models that are characterized by a massive number of parameters and require substantial computational resources for training and inference. These models are often designed to handle complex and high-dimensional data, enabling them to capture intricate patterns and relationships within the data. LLMs are often based on deep learning architectures like deep neural networks, convolutional neural networks (CNNs), or transformer models. Other models may include, for example, Rule-Based Natural Language Processing (NLP) Systems, Template-Bases Systems, Bag-of-Words algorithms, N-Gram models, Latent Semantic Analysis (LSA) models, etc. These additions/alternatives to natural language models have their specific use cases and limitations. Accordingly, in various embodiments, the systems and methods described herein may be configured to implement various models to achieve different results based on requested translations.

In the next phase of the NLM training, embodiments include incremental conversion of COBOL codes to modern languages such as Java, Golang or Angular, for example. In some embodiments, based on intended use cases and architecture requirements or other criteria, the system may be configured to recommend an optimal modern language to utilize. For example, if the intended use case includes mobile devices (e.g., Apple® or Android®), the system may be configured to translate the first coding language into a second coding language that is most appropriate based on its capability, performance, environment, and/or experience. In some embodiments, as part of initial conversion, the NLM may be instructed to generate unit test cases to follow a test-driven-development methodology. This approach may help build gradual and accurate output of data processed by the translated codes. In various embodiments, the translated-modern-codes may undergo rigorous and regression tests, e.g., based on historical input data and comparing the output data against the output of the original COBOL codes. The translated codes may include additional (or similar) logging, parameters, and/or control points to be leveraged by NLM to debug any discrepancies in the output datasets. The incremental debugging and refining of the translated-modern-codes may produce output data processing fidelity both at granular/functional modules.

In some embodiments, once a modernized code has achieved a high fidelity, e.g., based on predetermined thresholds or tests, a pre-production parallel environment may be established to allow simultaneous processing of production input data. Both lanes may be engineered to record intermediary data points, variables, values, etc., which, in some embodiments, may be leveraged post-processing to enhance debugging. The parallel runs may produce multiple, e.g., two, output data/results that may be reconciled and identified for any discrepancy. In some embodiments, until the output data/results are identical, or sufficiently similar to reach some predefined threshold of similarity, the NLM may continue to be enhanced while the modernized code continues to be updated to achieve a threshold consistency (e.g., 100% consistency). In some embodiments, enhanced modernized codes may also be retested on historical data to ensure a reasonable backward compatibility and processing result.

In some embodiments, once modernized codes achieve an acceptable data accuracy and performance, e.g., based on predefined thresholds, the modernized codes may be further segmented into microservices code. The modernized codes and/or sub-sections of its function may be measured for frequency and run-time duration. Various logging, parameters, and/or variables may be deployed to measure and track the usage. Such information may be collected in a separate performance database to record and trend operating metrics.

In some embodiments, as part of developing modernized code and data processing flows, systems and methods described herein may determine if the input data is processed in serial/sequential manner as opposed to using indexable values. Intended modernized processing logics may then dictate whether modernized microservice functions can be horizontally scaled (e.g., multi-thread) and/or increase in resource capacity so that optimized processing Service Level Agreements (SLAs) may be achieved.

In some embodiments, the performance database may also be configured to record the number of data volumes, transactions, sizes, and/or processing speeds so that, for each phase of intraday or overnight processing, multiple (e.g., every) layers of modernized and/or microservice code may be horizontally and/or dynamically scaled in anticipation of known and incoming transaction volumes from upstream systems. Additionally, the dynamically scaling may also calculate and determine additional resources required to meet upcoming SLAs and proactively allocate additional resources as necessary. These and other features are described in detail herein.

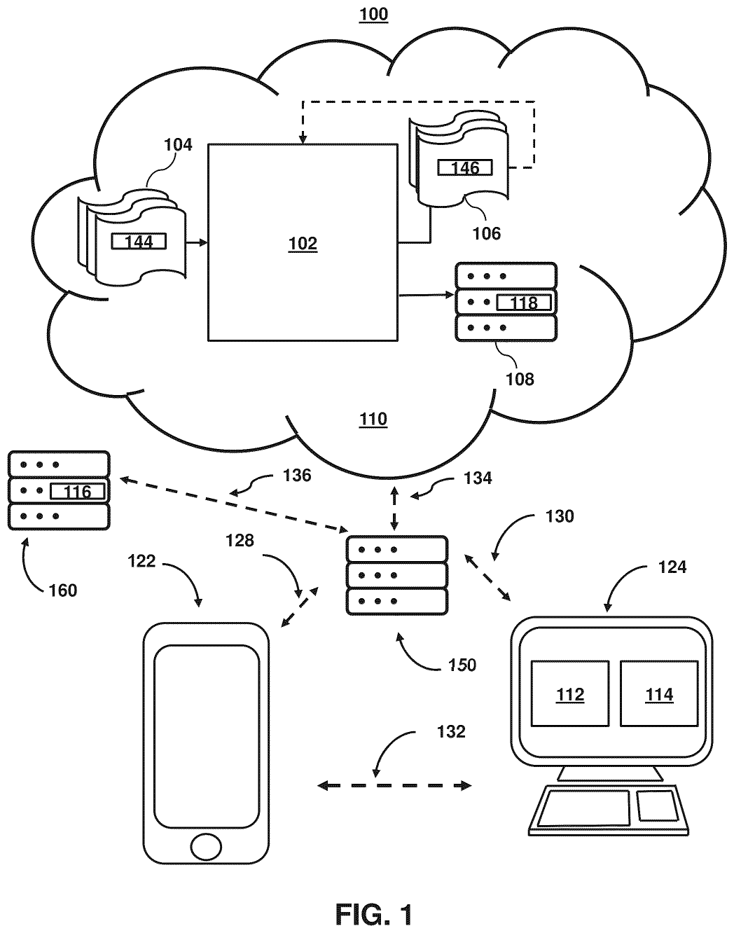

FIG. 1 depicts an illustrative system for translating a first coding language into a second coding language, in accordance with at least one embodiment. As shown in FIG. 1, system 100 may include user device 122, user device 124, mainframe 160, and/or other components. Each user device and/or mainframe 160 may include any type of mobile terminal, fixed terminal, or other device. Each of these devices may receive content and data via input/output (hereinafter “I/O”) paths and may also include processors and/or control circuitry to send and receive commands, requests, and other suitable data using the I/O paths. The control circuitry may be comprised of any suitable processing circuitry. Each of these devices may also include a user input interface and/or display for use in receiving and displaying data. For example, user device 122 and/or user device 124 may be any computer or computing device, including, but not limited to, a laptop computer, a tablet computer, a hand-held computer/computing device, other computer equipment (e.g., a server), including “smart,” wireless, wearable, and/or mobile devices, etc., which includes a processor, such as, e.g., processor 112. The processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some embodiments, processor 112 may comprise a plurality of processing units. These processing units may be physically located within the same device, or processor 112 may represent processing functionality of a plurality of devices operating in coordination.

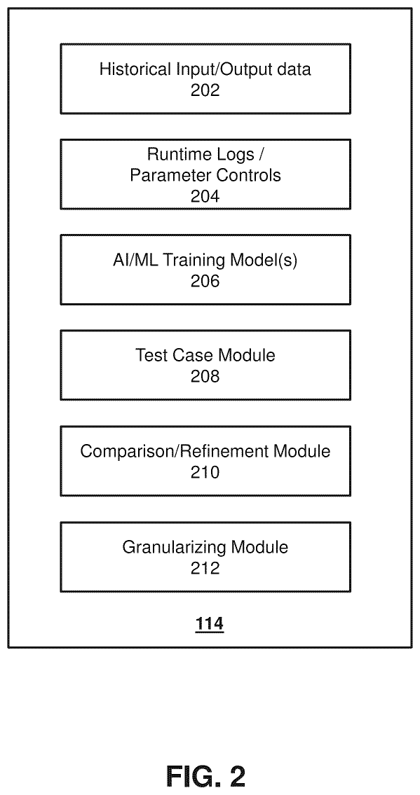

Processor 112 may be configured to execute or implement one or more of the features of a code translation application 114 (shown in detail in FIG. 2) by software; hardware; firmware; some combination of software, hardware, and/or firmware; and/or other mechanisms for configuring processing capabilities on processor 112. It should be appreciated that although features of the code translation application 114 are illustrated in FIG. 2 as being co-located in the user device 124, one or more of the components or features of the code translation application 114 may be located remotely from the other components or features. The description of the functionality provided by the different components or features of code translation application 114 described below is for illustrative purposes, and is not intended to be limiting, as any of the components or features of code translation application 114 may provide more or less functionality than is described, which is not to imply that other descriptions are limiting. For example, one or more of the components or features of code translation application 114 may be eliminated, and some or all of its functionality may be provided by others of the components or features of code translation application 114, again which is not to imply that other descriptions are limiting. As another example, processor 112 may include one or more additional components that may perform some or all of the functionality attributed below to one of the components or features of code translation application 114.

In some embodiments, the processor 112 may be programmed to execute one or more computer program components. The computer program components or features may include software programs and/or algorithms coded and/or otherwise embedded in the processor 112, for example. The one or more computer program components or features may include features of code translation application 114.

Users may, for instance, utilize one or more of the user devices to interact with one another, one or more servers, or other components of system 100. It should be noted that, while one or more operations are described herein as being performed by particular components of system 100, those operations may, in some embodiments, be performed by other components of system 100. As an example, while one or more operations are described herein as being performed by components of user device 124, including processor 112, those operations may, in some embodiments, be performed by components of user device 122 and/or mainframe 160. System 100 may also include cloud-based components 110, including cloud server 102, which may have services implemented on user device 122, user device 124, or mainframe 160, and/or may be accessible by communication paths 128, 130, 132, 134, or 136, respectively. Conversely, user device 122, user device 124, and/or mainframe 160, may access cloud-based components 110, via communication paths 128, 130, 132, 134, and/or 136. System 100 may receive data from remote servers (e.g., servers 108) and/or databases (e.g., databases 104, 106). It should also be noted that the cloud-based components in FIG. 1 may alternatively and/or additionally be non-cloud-based components. Additionally or alternatively, one or more components may be combined, replaced, and/or alternated. For example, system 100 may include databases 104, 106, and server 108, which may provide data to cloud server 102.

System 100 may also include a specialized network server (e.g., network server 150), which may act as a network gateway, router, and/or switches. Network server 150 may additionally or alternatively include one or more components of cloud-based components 110 for translating a first coding language into a second coding language. Network server 150 may comprise networking hardware used to allow data to flow from one discrete domain to another. Network server 150 may use more than one protocol to connect multiple networks and/or domains (as opposed to routers or switches) and may operate at any of the seven layers of the open systems interconnection model (OSI). It should also be noted that the functions and/or features of network server 150 may be incorporated into one or more other components of system 100, and the functions and/or features of system 100 may be incorporated into network server 150.

System 100 may further include a mainframe (e.g., mainframe 160). As noted herein, a mainframe is a high-performance, large-scale computer system designed to handle massive workloads and process a significant amount of data simultaneously. It typically serves as the central backbone for processing critical applications and services in industries like banking, finance, government, and large-scale enterprise environments. Mainframes typically use a symmetric multiprocessing (SMP) architecture, where multiple processors work in parallel to execute instructions. They also employ specialized hardware components like Channel Subsystems, I/O Processors, and Channel Pathways to efficiently manage input/output operations. A mainframe computer is used primarily by large organizations, e.g., for critical applications like bulk data processing for tasks such as censuses, industry and consumer statistics, enterprise resource planning, and large-scale transaction processing. Mainframes are used as the system of record for many organizations. Batch and online transactions processed by mainframes are often utilized by critical systems, both on and off the mainframe, for daily business processes and transactions. Mainframe 160 may run enterprise software and/or other computer operating code e.g., COBOL, referred to collectively as legacy code set 116, which may be difficult to directly integrate with other modernized computer code, e.g., those run in distributed environments, such as java. Accordingly, embodiments may enable translating a first coding language into a second coding language, as described herein.

Server 108 may run modernized computer code, e.g., modernized code set 118, which may be programmed to run in distributed environments, such as Java. Databases 104 and 106 may contain coding language specific data set 144 and coding language specific data set 146, respectively. As explained in detail herein, embodiments may train one or more machine learning and/or AI models based at least in part on various coding language specific data sets.

Each of the devices of system 100 may also include memory in the form of electronic storage. The electronic storage may include non-transitory storage media that electronically stores information. The electronic storage of media may include (i) system storage that is provided integrally (e.g., substantially non-removable) with servers or client devices and/or (ii) removable storage that is removably connectable to the servers or client devices via, for example, a port (e.g., a USB port, a firewire port, etc.) or a drive (e.g., a disk drive, etc.). The electronic storages may include optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

FIG. 1 may also include communication paths 128, 130, 132, 134, and/or 136. Communication paths 128, 130, 132, 134, and/or 136, may include the Internet, a mobile phone network, a mobile voice or data network (e.g., a 5G or LTE network), a cable network, a public switched telephone network, or other types of communications network or combinations of communications networks. Communication paths 128, 130, 132, 134, and/or 136 may include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

FIG. 2 illustrates an example code translation application, such as code translation application 114 of user device 124 (FIG. 1), according to at least one embodiment. In some embodiments, code translation application 114 may include historical input/output data 202, runtime logs/runtime logs/parameter controls 204, AI/ML training model 206, test case module 208, comparison/refinement module 210, and/or granularizing module 212, among other components. While these components are shown as being included in user device 124, in various embodiments, one or more of these components may be resident on and/or accessible via other elements of system 100. In some embodiments, input/output data 202 may be historical data inputted as a prompt into code translation application 114 and/or outputted as a result from code translation application 114. Inputs may include prompts and/or other code inputted into the system to elicit a response from the system. In some embodiments, runtime logs/parameter controls 204 may include various details and information regarding legacy code (e.g., legacy code set 116) and/or regarding modernized code (e.g., modernized code set 118), including runtime information, metadata, settings and other parameters associated with the various code sets. Such information may be analyzed or otherwise used to extract further information about the various code sets, improve training, etc.

In some embodiments, AI/ML training model 206 may represent one or a plurality of training models developed by employing AI and/or ML techniques and/or tools. For example, in some embodiments, AI/ML training model 206 may be one or more Natural Language Models (NLMs), which may be trained to accurately generate new modernized code based on older legacy code, as described herein. In some embodiments, test case module 208 may enable Test Driven Development (TDD) on newly generated software code. Test case module 208 may therefore enable predefined software requirements to be converted to test cases before software is fully developed, and/or may track software development by repeatedly testing the software against other (e.g., all) test cases. Thresholds may be set which define an initial fidelity level for generated code. Test case module 208 may then detect when generated code has reached a threshold and, e.g., send an alert to a user of user device 124.

In some embodiments, comparison/refinement module 210 may be configured to enable code translation application 114 to refine the generated code for use in production. As explained herein, once modernized code has reached a threshold fidelity, embodiments may be configured to run the code as pre-production code in parallel with production input code. Results of each code set may be compared and the pre-production code may be iteratively refined, e.g., until it is ready for production (e.g., until the legacy code can be replaced with the translated modernized code). In some embodiments, granularizing module 212 may then be implemented to granularize subsets of the modernized code into one or more containerized applications or programs (hereinafter referred to as “microservices”). Additionally or alternatively, granularizing module 212 may enable code translation application 114 to scale the modernized code horizontally and/or vertically, as described herein. These and other features are explained in further detail herein.

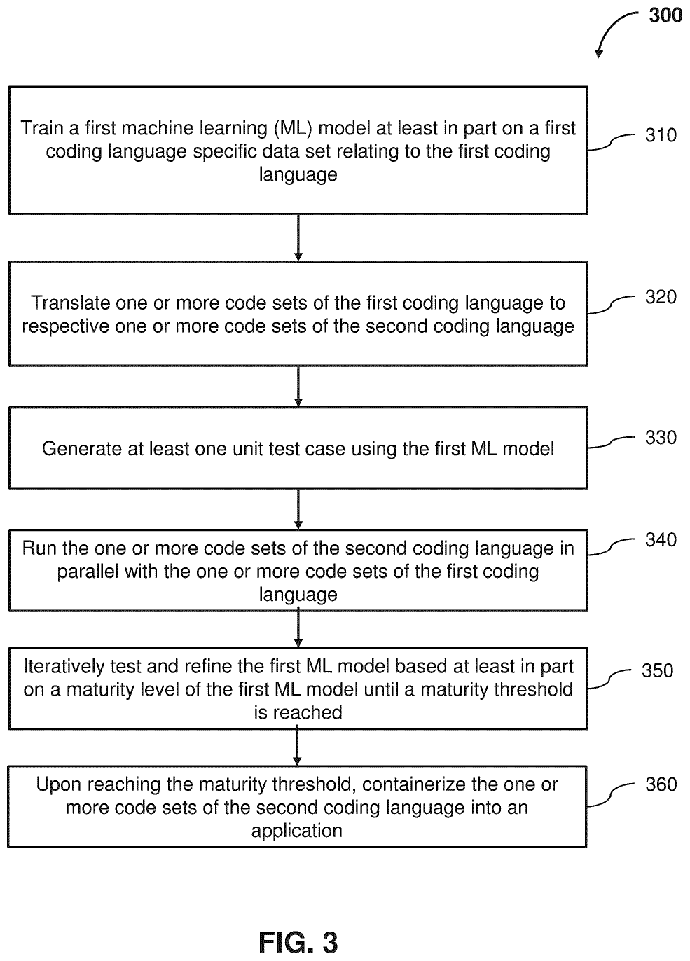

FIG. 3 depicts an example method 300 for translating a first coding language into a second coding language, in accordance with at least one embodiment. In various embodiments, method 300 may be implemented by system 100, executing code in one or more processors therein. For example, in some embodiments, method 300 may be performed on a computer (e.g., user device 124) having one or more processors and memory (not shown), and one or more code sets, applications, programs, modules, and/or other software (e.g., as shown in code translation application 114 of FIG. 2) stored in the memory and executing in or executed by the processor(s).

Method 300 begins at step 310 when the processor is configured to train a first machine learning (ML) model at least in part on a first coding language specific data set relating to a first coding language. In order to generate accurate Natural Language Models (NLMs) for legacy code sets (e.g., COBOL), embodiments train or otherwise access a legacy language knowledge set. This information may be based on various language reference documents, samples, examples, codes, and/or other sources (e.g., internal and/or external database libraries and resources), historical input files, historical output files, runtime logs, parameter sets, and/or control points, relating to a first coding language. Similarly, in some embodiments, the processor may be configured to train a second ML model with a modernized language knowledge set for a target modernized language (e.g., Java, Golang, Python, Angular, and/or C++, etc.). In some embodiments, developing separate models for each language may further enhance translation between coding languages, e.g., enabling reverse translation to test accuracy, parallel execution for comparison purposes, etc.

In some embodiments, prior to processing the first coding language into the first ML model, any variables, subfunctions, and/or any other source codes that are not programmatically required (e.g., dead and/or unreachable codes) or referenced may be excluded and/or commented out. Similarly, in some embodiments, prior to processing the second coding language into the second ML model, any variables, subfunctions, and/or any other source codes that are not programmatically required (e.g., dead and/or unreachable codes) or referenced may be excluded and/or commented out.

In some embodiments, prior to processing the first coding language into the first ML model, any source code(s) may be incorporated and/or may expand on all relevant copybook, library, header files, etc., that are referenced in the source code(s). Similarly, in some embodiments, prior to processing the second coding language into the second ML model, any source code(s) may be incorporated and/or may expand on all relevant copybook, library, header files, etc., that are referenced in the source code(s).

In various embodiments, training of the ML model(s) may be implemented using one or more of a number of machine learning and/or AI techniques. For example, embodiments may train one or more word embeddings based on each coding language specific data, for example, using existing tools, e.g., algorithms that learn word embeddings by predicting context words given a target word (Continuous Bag of Words—CBOW) or predicting a target word given its context (Skip-gram); unsupervised learning algorithms that combine global matrix factorization techniques with local context window-based methods to learn word embeddings; algorithms that use subword information (character n-grams) to handle out-of-vocabulary words; among others. Word embedding, as understood herein, is the collective name for a set of language modeling and feature learning techniques in natural language processing (NLP) in which words or phrases from a given vocabulary are mapped to vectors of real numbers. Conceptually this involves a mathematical embedding from a space with one dimension per word to a continuous vector space with a much lower dimension. In some embodiments, one or more of these NLP techniques may be implemented in order to create the word embeddings, which may inform the ML models of method 300. Those skilled in the art will recognize that many different ML/AI training tools may be used to train the ML models. For example, in various embodiments, one or more of Sentiment Analysis, Named Entity Recognition, Summarization, Topic Modeling, Text Classification, Keyword Extraction, Lemmatization and Stemming, and/or other NLP, ML, and/or AI techniques may be applied to train the ML models.

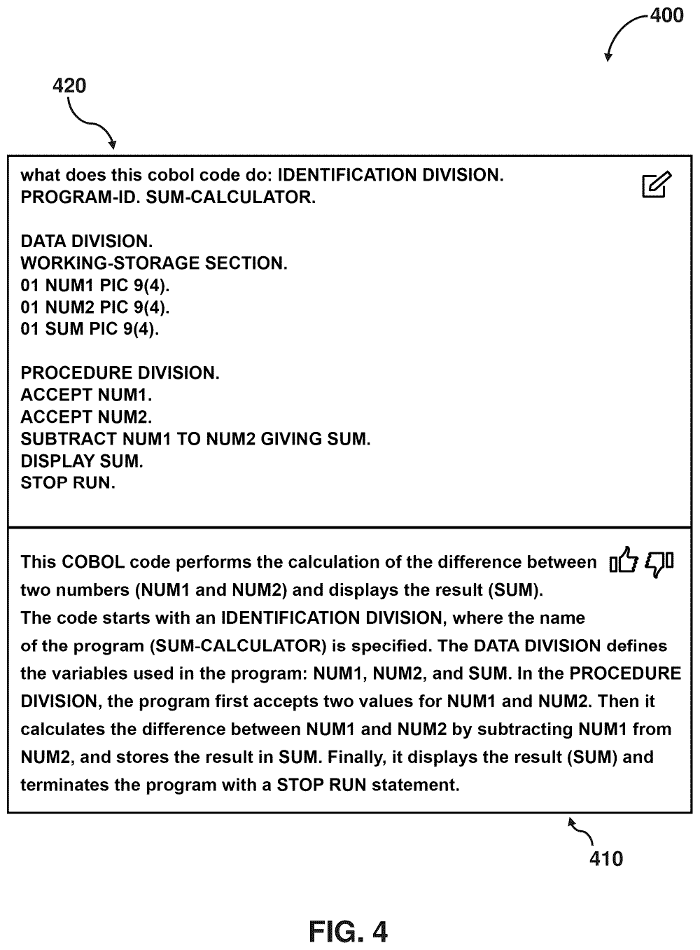

In some embodiments, once the foundational language knowledge sets have been established for a given language, the processor may enable the NLM to process the first coding language (e.g., legacy code sets such as mainframe COBOL codes), their libraries and any other documents and structures. This phase of the ML training may allow the NLM to be exposed to specific legacy applications (e.g., COBOL code sets) and related data sets to build its own understanding of the functions and logics of the legacy code sets. In some embodiments, to test NLM maturity, e.g., with respect to predefined threshold maturity, the processor may be configured to produce or otherwise generate a layman summary of specific portions of the legacy code sets (e.g., COBOL applications), including, for example, functions, logics, etc. This process may be beneficial in documenting institutional knowledge and creating a basis for version-controlled code enhancements. FIG. 4 shows an example 400 of a layman summary 410 produced based on a COBOL code set 420.

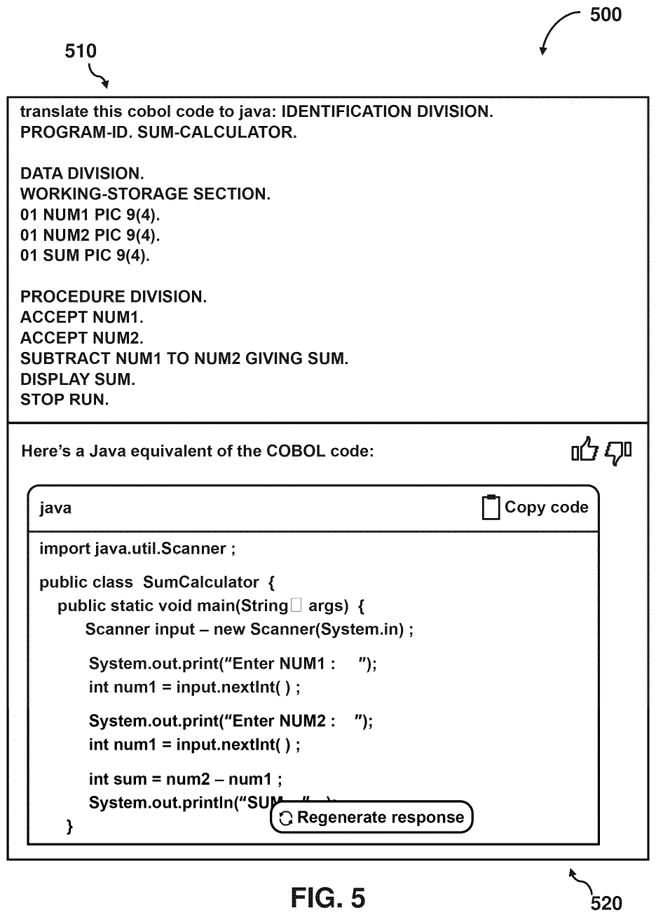

At step 320, in some embodiments, the processor may translate one or more code sets of the first coding language to respective one or more code sets of the second coding language. For example, in some embodiments, the processor may be configured to receive or retrieve a legacy code set (e.g., a COBOL code set) and translate the legacy code set to a modernize code set (e.g., Java, Go-lang, Angular, etc.), employing one or more ML models. As noted previously, embodiments may employ one or more AI/ML training models to identify text, functions, logic, and other information etc., from a first code set, and translate the first code set into a second code set, with the intent of having the newly generated code set be as functionally and logically similar to the original code set as possible. In some embodiments, the processor may be configured to execute an incremental and/or iterative conversion of legacy code sets to modern coding languages, and monitor the process as described herein. FIG. 5 shows an example 500 of a legacy code set 510 and a translated modernized code set 520, according to some embodiments.

At step 330, in some embodiments, the processor may generate at least one unit test case using the first ML model. As part of the translation/conversion process, in some embodiments, the processor may employ the NLM to generate one or more unit test cases to follow a test-driven-development methodology. This approach may help build gradual and accurate output of data processed by the translated codes. In some embodiments, the translated modernized codes may undergo rigorous testing, including regression tests based on historical input data and comparing the output data against the output of the original code sets.

In some embodiments, the processor may track the progress of the at least one test case based at least in part on the maturity level of the first ML model. Various metrics relating to, e.g., processing time, processing power usage, processing efficiency, accuracy of output, memory consumption, etc., may be tracked and compared to predefined thresholds. In some embodiments, the translated models may include additional and/or similar logging, parameters, and control points as the legacy models, and the processor may leverage the NLMs to debug any discrepancies in the output datasets. The incremental debugging and refining of the translated-modern-codes may produce output data processing fidelity both at granular and functional levels.

At step 340, in some embodiments, the processor may run the one or more code sets of the second coding language in parallel with the one or more code sets of the first coding language. In some embodiments, once the modernized code sets have achieved a high fidelity, e.g., with respect to one or more predefined thresholds, the processor may execute or otherwise establish a pre-production parallel environment to allow simultaneous processing alongside production input data. By analyzing the outputs of legacy code sets (in production) and their translated modernized code sets (in the pre-production environment) in parallel and substantially in real time, the system may be able to identify and/or address issues with the translated code set and further modify the respective training models. In some embodiments, both lanes may be engineered to record intermediary data points, variables, values, etc., which may be leveraged post-processing to enhance debugging. In some embodiments, a user interface may be provided which may display both code sets running in parallel, and may provide the ability for a user to edit the pre-production code, e.g., in real time, to provide input, correct or otherwise flag bugs or issues to be addressed (in the code and/or in the ML models).

At step 350, in some embodiments, the processor may iteratively test and refine the first ML model based at least in part on a maturity level of the first ML model until a maturity threshold is reached. In some embodiments, the processor may implement a plurality of iterative regression tests for the newly translated modernized code sets running in the pre-production environment based on historical input data of at least one of the one or more code sets of the first coding language (e.g., COBOL) and comparing corresponding output data of the first ML model against historical output of the at least one of the one or more code sets of the first coding language.

In some embodiments, the processor may execute one or more debugging techniques, and update the first ML model based on the one or more executed debugging techniques. In some embodiments, the parallel runs may produce respective sets of output data/results which may be reconciled and identified for any discrepancy. In some embodiments, until the output data/results are identical or within a predefined margin of error, the NLM may continue to be enhanced and the modernized code sets may continue to be updated to achieve, e.g., 100% consistency (or a predefined consistency/accuracy). In some embodiments, enhanced modernized codes may be retested, e.g., periodically or regularly, on historical data to ensure a reasonable backward compatibility and processing result. In some embodiments, one or more debugging techniques may be enabled on the first coding language to build and/or model typical sequential order of operation of program execution flows.

At step 360, in some embodiments, the processor may, upon reaching the maturity threshold, containerize the one or more code sets of the second coding language into an application. For example, in some embodiments, once the processor has determined that the modernized code set has achieved an acceptable data accuracy and/or performance, e.g., an accuracy and/or performance meeting predefined criteria, metrics, and/or thresholds, the modernized code set may be further segmented into one or more programs, applications, or other containerized code sets, collectively referred to as microservices code. In some embodiments, the modernized code sets and/or sub-sections of its functions may be measured for key metrics such as frequency and run-time duration. In some embodiments, various logging, parameters, variables, etc., may be deployed to measure and track the usage, e.g., for quality control purposes. Such information may be collected, e.g., in a separate performance database to record and trend operating metrics. Additionally or alternatively, such information may be fed back to ML models to further optimize the models and the resulting outputs.

In some embodiments, as part of developing the modernized code sets and data processing flows, the processor may be configured to determine if input data to the code is processed in serial/sequential manner or using indexable values. Intended modernized processing logics may then dictate whether microservice functions generated from the modernized code sets can be horizontally scaled (e.g., multi-thread) and/or increase in resource capacity, e.g., so that optimized processing SLA can be achieved. In some embodiments, the processor may be configured to identify and/or recommend additional implementations for containerized microservices generated from the modernized code sets, e.g., across various platforms and/or for different services.

In some embodiments, the processor may be configured to record, e.g., in a performance database, the number of data volumes, transactions, sizes, and/or processing speeds of various microservices and applications generated from the modernized code set. Accordingly, for each phase of intraday or overnight processing, each layer of modernized code set and/or microservice code sets can be horizontally and/or dynamically scaled in anticipation of known and incoming transaction volumes from upstream systems. In some embodiments, the dynamically scaling may also calculate and determine additional resources required to meet upcoming SLAs. In some embodiments, the processor may implement the ML models to determine dynamic scaling algorithms based on how the original processing (e.g., top-down (FIFO) or multi-threaded or some index of key dataset) was executed.

In some embodiments, the processor may employ the ML models to measure the processing throughput performance of dynamically scalable logics and/or proactively scale downstream processes based on upstream volume signals. As new modernized code sets are developed, in some embodiments, the processor may be configured to document, tag, or otherwise reference (e.g., in a library database) the functionality and/or other details of the modernized code sets and/or the containerized microservices created therefrom. Accordingly, as new services or functions are required or requested, in some embodiments, the processor may be configured to search for relevant code sets which may be deployed.

In some embodiments, the processor may be configured to provide translation recommendations. For example, in some embodiments, trained ML models may be configured to recommend a target language for a given legacy language based on desired use cases, target systems/platforms, required functionalities, etc. For example, the processor may identify segments of COBOL mainframe code which may be ripe for translation and implementation as a Java application or microservice and may recommend execution of the systems and methods described herein for the purposes of creating the modernized code set.

In some embodiments, the processor may dynamically scale one or more containerized applications, e.g., based at least in part on one or more of a second ML model (e.g., of a second modernized coding language, an ML model for prioritizing containerized code sets, etc.) or at least one second unit test case that has reached the maturity threshold. As noted above, in some embodiments, the processor may be configured implement further AI and/or ML tools to learn from results of prior translations, execute further testing, e.g., via additional unit test case, etc., and produce further recommendations and/or improvements. Such recommendations and/or improvements may be automatically integrated into any of the above noted processes, to further improve the system described herein.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Clause 1. A method for translating a first coding language into a second coding language, comprising: training, by a processor, a first machine learning (ML) model at least in part on a first coding language specific data set relating to the first coding language, wherein the first ML model is trained to translate one or more code sets of the first coding language to respective one or more code sets of the second coding language; using the first ML model, generating, by the processor, at least one unit test case, wherein the at least one unit test case runs the one or more code sets of the second coding language in parallel with the one or more code sets of the first coding language; iteratively testing and refining, by the processor, the first ML model based at least in part on a maturity level of the first ML model until a maturity threshold is reached; and upon reaching the maturity threshold, containerizing by the processor, the one or more code sets of the second coding language into an application.

Clause 2. The method of clause 1, wherein the first coding language specific data set comprises one or more of at least one of a language reference document, library, historical input file, historical output file, runtime log, parameter set, or control point, relating to a first coding language. Clause 3. The method of clause 1, wherein the first coding language is Common Business-Oriented Language (COBOL).

Clause 4. The method of clause 1, wherein the second coding language is one of Java, Golang, Python, Angular, or C++.

Clause 5. The method of clause 1, wherein the first machine learning model is a Natural Language Model (NLM).

Clause 6. The method of clause 1, wherein iteratively testing the first ML model comprises: implementing a plurality of iterative regression tests based on historical input data of at least one of the one or more code sets of the first coding language and comparing corresponding output data of the first ML model against historical output of the at least one of the one or more code sets of the first coding language.

Clause 7. The method of clause 6, wherein iteratively refining the first ML model comprises: executing, by the processor, one or more debugging techniques; and updating the first ML model based on the one or more executed debugging techniques.

Clause 8. The method of clause 1, further comprising: dynamically scaling, by the processor, one or more containerized applications based at least in part on one or more of a second ML model or at least one second unit test case that has reached the maturity threshold.

Clause 9. The method as in clause 1, further comprising: tracking, by the processor, progress of the at least one test case based at least in part on the maturity level of the first ML model.

Clause 10. A system for translating a first coding language into a second coding language, comprising: a computer having a processor and a memory; and one or more code sets stored in the memory and executed by the processor, which, when executed, configure the processor to: train a first machine learning (ML) model at least in part on a first coding language specific data set relating to the first coding language, wherein the first ML model is trained to translate one or more code sets of the first coding language to respective one or more code sets of the second coding language; using the first ML model, generate at least one unit test case, wherein the at least one unit test case runs the one or more code sets of the second coding language in parallel with the one or more code sets of the first coding language; iteratively test and refine the first ML model based at least in part on a maturity level of the first ML model until a maturity threshold is reached; and upon reaching the maturity threshold, containerize the one or more code sets of the second coding language into an application.

Clause 11. The system of clause 10, wherein the first coding language specific data set comprises one or more of at least one of a language reference document, library, historical input file, historical output file, runtime log, parameter set, or control point, relating to a first coding language.

Clause 12. The system of clause 10, wherein the first coding language is Common Business-Oriented Language (COBOL).

Clause 13. The system of clause 10, wherein the second coding language is one of Java, Golang, Python, Angular, or C++.

Clause 14. The system of clause 10, wherein the first machine learning model is a Natural Language Model (NLM).

Clause 15. The system of clause 10, wherein, when iteratively testing the first ML model, the processor is further configured to: implement a plurality of iterative regression tests based on historical input data of at least one of the one or more code sets of the first coding language and comparing corresponding output data of the first ML model against historical output of the at least one of the one or more code sets of the first coding language.

Clause 16. The system of clause 15, wherein when iteratively refining the first ML model, the processor is further configured to: execute one or more debugging techniques; and update the first ML model based on the one or more executed debugging techniques.

Clause 17. The system of clause 10, wherein the processor is further configured to: dynamically scale one or more containerized applications based at least in part on one or more of a second ML model or at least one second unit test case that has reached the maturity threshold.

Clause 18. The system of clause 10, wherein the processor is further configured to: track progress of the at least one test case based at least in part on the maturity level of the first ML model.

Clause 19. A non-transitory computer-readable medium storing computer-program instructions that, when executed by one or more processors, cause the one or more processors to effectuate operations comprising: training a first machine learning (ML) model at least in part on a first coding language specific data set relating to the first coding language, wherein the first ML model is trained to translate one or more code sets of the first coding language to respective one or more code sets of the second coding language; using the first ML model, generating at least one unit test case, wherein the at least one unit test case runs the one or more code sets of the second coding language in parallel with the one or more code sets of the first coding language; iteratively testing and refining the first ML model based at least in part on a maturity level of the first ML model until a maturity threshold is reached; and upon reaching the maturity threshold, containerizing the one or more code sets of the second coding language into an application.

Clause 20. The non-transitory computer-readable medium of clause 19, wherein the first coding language is Common Business-Oriented Language (COBOL); and wherein the second coding language is one of Java, Golang, Python, Angular, or C++.

What is claimed is:

1. A method for translating a first coding language into a second coding language, comprising:
training, by a processor, a first machine learning (ML) model at least in part on a first coding language specific data set relating to the first coding language,
wherein the first ML model is trained to translate one or more code sets of the first coding language to respective one or more code sets of the second coding language;
using the first ML model, generating, by the processor, at least one unit test case,
wherein the at least one unit test case runs the one or more code sets of the second coding language in parallel with the one or more code sets of the first coding language;
iteratively testing and refining, by the processor, the first ML model based at least in part on a maturity level of the first ML model until a maturity threshold is reached;
and
upon reaching the maturity threshold, containerizing by the processor, the one or more code sets of the second coding language into an application.

2. The method of claim 1, wherein the first coding language specific data set comprises one or more of at least one of a language reference document, library, historical input file, historical output file, runtime log, parameter set, or control point, relating to a first coding language.

3. The method of claim 1, wherein the first coding language is Common Business-Oriented Language (COBOL).

4. The method of claim 1, wherein the second coding language is one of Java, Golang, Python, Angular, or C++.

5. The method of claim 1, wherein the first machine learning model is a Natural Language Model (NLM).

6. The method of claim 1, wherein iteratively testing the first ML model comprises:
implementing a plurality of iterative regression tests based on historical input data of at least one of the one or more code sets of the first coding language and comparing corresponding output data of the first ML model against historical output of the at least one of the one or more code sets of the first coding language.

7. The method of claim 6, wherein iteratively refining the first ML model comprises:
executing, by the processor, one or more debugging techniques; and
updating the first ML model based on the one or more executed debugging techniques.

8. The method of claim 1, further comprising:
dynamically scaling, by the processor, one or more containerized applications based at least in part on one or more of a second ML model or at least one second unit test case that has reached the maturity threshold.

9. The method as in claim 1, further comprising:
tracking, by the processor, progress of the at least one test case based at least in part on the maturity level of the first ML model.

10. A system for translating a first coding language into a second coding language, comprising:
a computer having a processor and a memory; and
one or more code sets stored in the memory and executed by the processor, which, when executed, configure the processor to:
train a first machine learning (ML) model at least in part on a first coding language specific data set relating to the first coding language,
wherein the first ML model is trained to translate one or more code sets of the first coding language to respective one or more code sets of the second coding language;
using the first ML model, generate at least one unit test case,
wherein the at least one unit test case runs the one or more code sets of the second coding language in parallel with the one or more code sets of the first coding language;
iteratively test and refine the first ML model based at least in part on a maturity level of the first ML model until a maturity threshold is reached;
and
upon reaching the maturity threshold, containerize the one or more code sets of the second coding language into an application.

11. The system of claim 10, wherein the first coding language specific data set comprises one or more of at least one of a language reference document, library, historical input file, historical output file, runtime log, parameter set, or control point, relating to a first coding language.

12. The system of claim 10, wherein the first coding language is Common Business-Oriented Language (COBOL).

13. The system of claim 10, wherein the second coding language is one of Java, Golang, Python, Angular, or C++.

14. The system of claim 10, wherein the first machine learning model is a Natural Language Model (NLM).

15. The system of claim 10, wherein, when iteratively testing the first ML model, the processor is further configured to:
implement a plurality of iterative regression tests based on historical input data of at least one of the one or more code sets of the first coding language and comparing corresponding output data of the first ML model against historical output of the at least one of the one or more code sets of the first coding language.

16. The system of claim 15, wherein when iteratively refining the first ML model, the processor is further configured to:
execute one or more debugging techniques; and
update the first ML model based on the one or more executed debugging techniques.

17. The system of claim 10, wherein the processor is further configured to:
dynamically scale one or more containerized applications based at least in part on one or more of a second ML model or at least one second unit test case that has reached the maturity threshold.

18. The system of claim 10, wherein the processor is further configured to:
track progress of the at least one test case based at least in part on the maturity level of the first ML model.

19. A non-transitory computer-readable medium storing computer-program instructions that, when executed by one or more processors, cause the one or more processors to effectuate operations comprising:
training a first machine learning (ML) model at least in part on a first coding language specific data set relating to the first coding language,
wherein the first ML model is trained to translate one or more code sets of the first coding language to respective one or more code sets of the second coding language;
using the first ML model, generating at least one unit test case,
wherein the at least one unit test case runs the one or more code sets of the second coding language in parallel with the one or more code sets of the first coding language;
iteratively testing and refining the first ML model based at least in part on a maturity level of the first ML model until a maturity threshold is reached; and
upon reaching the maturity threshold, containerizing the one or more code sets of the second coding language into an application.

20. The non-transitory computer-readable medium of claim 19, wherein the first coding language is Common Business-Oriented Language (COBOL); and
wherein the second coding language is one of Java, Golang, Python, Angular, or C++.
